(19) United States
(12) Patent Application Publication
(10) Pub. No.: US 2024/0430708 A1
(43) Pub. Date: Dec. 26, 2024

(54) COMMUNICATION APPARATUS, CONTROL METHOD FOR COMMUNICATION APPARATUS, AND STORAGE MEDIUM

(71) Applicant: CANON KABUSHIKI KAISHA, Tokyo (JP)

(72) Inventor: TOSHIYUKI NAKAGAWA, Kanagawa (JP)

(21) Appl. No.: 18/825,406

(22) Filed: Sep. 5, 2024

Related U.S. Application Data
(63) Continuation of application No. PCT/JP2023/005406, filed on Feb. 16, 2023.

(30) Foreign Application Priority Data
Mar. 11, 2022 (JP) 2022-038179

(51) Int. Cl. H04W 24/02; H04W 8/00; H04W 8/22; H04W 84/12

(52) U.S. Cl. CPC H04W 24/02; H04W 8/005; H04W 8/22; H04W 84/12

(57) ABSTRACT

A Wi-Fi Aware compliant frame is to be communicated which includes information indicating that a communication apparatus supports an IEEE 802.11be standard and that the communication apparatus is capable of using a frequency bandwidth exceeding 160 MHz.

### CROSS-REFERENCE TO RELATED APPLICATIONS

This application is a Continuation of International Patent Application No. PCT/JP2023/005406, filed Feb. 16, 2023, which claims the benefit of Japanese Patent Application No. 2022-038179, filed Mar. 11, 2022, both of which are hereby incorporated by reference herein in their entirety.

### TECHNICAL FIELD

The present invention relates to a wireless communication technique for a communication apparatus.

### BACKGROUND ART

In recent years, a wireless LAN system compliant with IEEE 802.11 has been widely used. Along with this, a technique for easily discovering a neighboring wireless LAN application and information in an energy saving manner has been proposed. As a communication standard for discovering a communication apparatus, a service provided by the communication apparatus, and the like in an energy saving manner, Wi-Fi Aware is established by Wi-Fi Alliance. PTL 1 describes Neighbor Awareness Networking (NAN) established by Wi-Fi Alliance as a standard for discovering a communication apparatus, a service provided by it, and the like in an energy saving manner. Here, Wi-Fi Aware and the NAN standard refer to the same.

On the other hand, for wireless local area network (LAN) techniques, standards are established by IEEE 802.11 that is a standards body for wireless LAN techniques, and standards for wireless LAN techniques include IEEE 802.11/a/b/g/n/ac/ax and the like. Here, IEEE is an abbreviation for Institute of Electrical and Electronics Engineers. At the moment, IEEE 802.11 carries out standard establishment for an IEEE 802.11be standard, and according to the IEEE 802.11be standard, communication in a frequency bandwidth exceeding 160 MHz is under review.

### CITATION LIST

### Patent Literature

PTL 1 U.S. Patent Application Publication No. 2014/0302787

However, according to Wi-Fi Aware standards up to now, a mechanism for notification is not defined about communication compliant with an IEEE 802.11be standard to be performed and communication in a frequency bandwidth exceeding 160 MHz to be performed.

### SUMMARY OF INVENTION

The present invention has been made in view of the above-described problem and aims to enable, in a Wi-Fi Aware standard, notification of information regarding communication compliant with an IEEE 802.11be standard.

To solve the above-described problem, a communication apparatus according to the present invention is a Wi-Fi Aware compliant communication apparatus including a communication unit configured to communicate a Wi-Fi Aware compliant frame, in which the frame communicated by the communication unit includes first information indicating that the communication apparatus supports an IEEE 802.11be standard.

In addition, a communication apparatus according to the present invention is a Wi-Fi Aware compliant communication apparatus including a communication unit configured to communicate a Wi-Fi Aware compliant frame, in which the frame communicated by the communication unit includes first information indicating that the communication apparatus is capable of using a frequency bandwidth exceeding 160 MHz.

Further features of the present invention will become apparent from the following description of exemplary embodiments with reference to the attached drawings.

### BRIEF DESCRIPTION OF DRAWINGS

FIG. 1 illustrates a configuration example of a wireless communication system.

FIG. 2 is a block diagram illustrating a hardware configuration example of a NAN 101.

FIG. 3 is a block diagram illustrating a functional configuration example of the NAN 101.

FIG. 4 is a diagram illustrating a frame format of an extended service discovery frame (SDF) in the present embodiment.

FIG. 5 is a diagram illustrating detailed information included in an operation mode field in the present embodiment.

FIG. 6 is a diagram illustrating a frame format of the extended service discovery frame (SDF) in the present embodiment.

FIG. 7 is a diagram illustrating detailed information of an extended operation mode field in the present embodiment.

FIG. 8 is a diagram illustrating a frame format of the extended service discovery frame (SDF) in the present embodiment.

FIG. 9 is a diagram illustrating detailed information included in the operation mode field in the present embodiment.

FIG. 10 is a diagram illustrating detailed information of an extended operating bandwidth field in the present embodiment.

### DESCRIPTION OF EMBODIMENTS

Hereinafter, embodiments of the present invention will be described with reference to the drawings. It is noted that hereinafter, each of communication apparatuses is assumed to be a communication apparatus having a wireless LAN communication function compliant with an IEEE 802.11 standard series, but is not limited to this. In addition, each of the following communication apparatuses is assumed to be a NAN device capable of discovering another communication apparatus and a service provided by it through NAN established by Wi-Fi Alliance, but is not also limited to this. That is, in each of the following explanations, a technical term corresponding to a predetermined standard is used, but each of the following discussions can also be applied to other standards of the same type.

Neighbor Awareness Networking (NAN) will be described. In NAN, communication of service information is performed in a period referred to as a discovery window (hereinafter, described as a DW). As will be described below, the service information refers to a subscribe message that is a signal for discovering a service, a publish message that is a signal for notification of provision of a service, and the like. In addition, the DW is a time period which is established for each channel and in which a plurality of devices that execute NAN can converge. In addition, a set of communication apparatuses sharing a schedule of the DW is referred to as a NAN cluster.

Each of the communication apparatuses belonging to the NAN cluster operates in any of roles among a master, a non-master sync, and a non-master non-sync. A communication apparatus operating as the master transmits a NAN synchronization beacon (hereinafter, described as a sync beacon) that is a beacon for each of the communication apparatuses to identify the DW and synchronize. In addition, the communication apparatus operating as the master transmits, to a communication apparatus which does not belong to the NAN cluster, a NAN discovery beacon that is a signal for the communication apparatus to recognize the NAN cluster. The NAN discovery beacon is transmitted, for example, every 100 TU (time unit, 1 TU is 1024 microseconds) even outside the period of the DW. It is noted that in each of NAN clusters, at least one communication apparatus operates as the master.

A communication apparatus operating as the non-master sync transmits the NAN sync beacon but does not transmit the NAN discovery beacon. A communication apparatus operating as the non-master non-sync transmits neither the NAN sync beacon nor the NAN discovery beacon. The communication apparatuses participating in the NAN cluster synchronize in the DW period for each predetermined cycle following the NAN sync beacon, and communicate the service information in the DW period. Specifically, each of the communication apparatuses mutually communicates the subscribe message that is the signal for discovering the service in the DW period and the publish message that is the signal for notification of the provision of the service. Furthermore, each of the communication apparatuses can exchange a follow-up message for exchanging additional information related to the service in the DW period. It is noted that messages such as publish, subscribe, and follow-up are collectively referred to as a service discovery frame (SDF). Each of the communication apparatuses can perform advertisement or detection of the service by exchanging the SDF.

In general, after a service is discovered/detected, the NAN device sometimes performs communication associated with an application for actually executing the service. In this case, the NAN device may establish PostNAN for communication related to the application instead of NAN. The PostNAN is a network separate from the NAN cluster. The PostNAN includes, for example, an infrastructure network, infra basic service set (IBSS), Wi-Fi Direct, and the like. The NAN device establishes the PostNAN to be able to perform the communication based on the application in a period other than the DW period.

In addition, without configuring a network such as the PostNAN which is different from the NAN cluster, the NAN device can establish connection with another NAN device in NAN on a one-to-one basis to perform communication related to the application. The communication related to the application compliant with a NAN standard is referred to as NDP (NAN data path). The NAN device can execute the NDP in a period which does not overlap the DW period in the NAN cluster. In this case, before the NDP is executed on a one-to-one basis, the NAN device can execute a negotiation with regard to timing (period) at which the NDP is executed on a one-to-one basis with a NAN device of a partner apparatus of the communication.

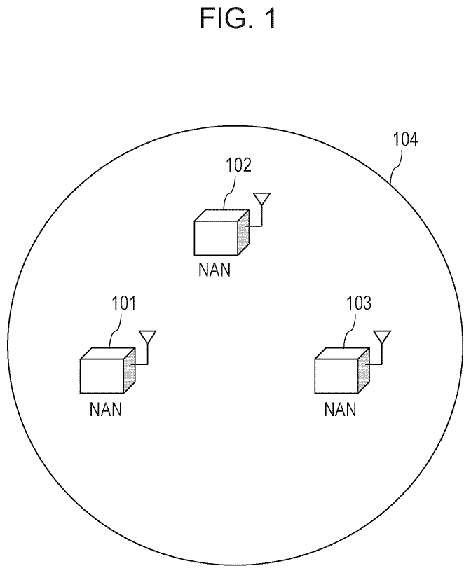

A configuration example of a wireless communication system of one embodiment of the present invention will be described by using FIG. 1. The wireless communication system of the present embodiment is configured by including a NAN 101 to a NAN 103 each of which is a communication apparatus (NAN device) following the NAN standard, and the NANs 101 to 103 participate in a NAN cluster 104. According to the present embodiment, the NAN devices (NANs 101 to 103) participating in the NAN cluster 104 constitute a network at a frequency channel 6 (6 ch) in a 2.4 GHz band. Herein, the NAN cluster 104 is a NAN cluster in which a length of the DW period is 16 TU and also a time interval from starting timing of the DW period to starting timing of the next DW period is 512 TU. In addition, the DW period is a period in which 16 pieces of DW periods of DW0 to DW15 are set as one cycle, and a DW period 16 pieces later than DWn (n is an integer from 0 to 15) is also DWn. That is, DW16 is equivalent to the next DW0. It is assumed that the NAN 101 to the NAN 103 participating in the NAN cluster 104 can certainly receive a wireless signal in at least DW0.

The NAN 101 is a communication apparatus capable of executing each processing described below. It is assumed that the NAN 101 is participating in the NAN cluster 104 as the non-master non-sync. The NAN 102 is a communication apparatus which participates in the NAN cluster 104 as the master. The NAN 102 receives the wireless signal in all the DW periods and further transmits the NAN sync beacon in all the DW periods. The NAN 103 is a communication apparatus participating in the NAN cluster 104 as the non-master non-sync.

The NAN devices 101, 102, and 103 participating in the NAN cluster 104 can execute wireless communication compliant with an IEEE 802.11be standard. In addition, the NAN devices 101, 102, and 103 can communicate at frequencies in a 2.4 Hz band, a 5 GHz band, and a 6 GHz band. The frequency band used by each of the communication apparatuses is not limited to this, and a 60 GHz band may be used, for example. In addition, the NAN devices 101, 102, and 103 can communicate by using bandwidths of 20 MHZ, 40 MHZ, 80 MHZ, 160 MHZ, and 320 MHz. The bandwidth used by each of the communication apparatuses is not limited to this, and bandwidths of 240 MHZ, 4 MHZ, and the like may be used, for example.

It is noted that the NAN devices 101, 102, and 103 are set to support the IEEE 802.11be standard, but in addition to this, may support legacy standards that are standards earlier than the IEEE 802.11be standard. Specifically, the NAN devices 101, 102, and 103 may support at least any one of IEEE 802.11a/b/g/n/ac/ax standards. Alternatively, the NAN devices may support standards that are to be successors to IEEE 802.11be.

### Configuration of the NAN 101

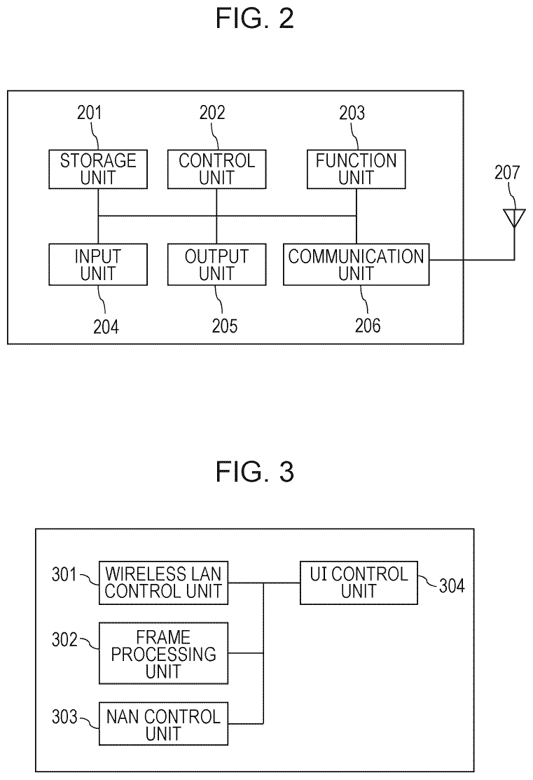

FIG. 2 illustrates a hardware configuration of the NAN 101 according to the present embodiment. As an example of the hardware configuration, the NAN 101 has a storage unit 201, a control unit 202, a function unit 203, an input unit 204, a display unit 205, a communication unit 206, and an antenna 207.

The storage unit 201 is constituted by both, or any one of, one or more read only memories (ROMs) and one or more random access memories (RAMs). The storage unit 201 stores programs for performing various operations described below and various information such as communication parameters for wireless communication. It is noted that in addition to the memories such as the ROM and the RAM, storage media such as a flexible disc, a hard disc, an optical disc, a magnetooptical disc, a CD-ROM, a CD-R, a magnet tape, a nonvolatile memory card, and a DVD may be used as the storage unit 201.

The control unit 202 is constituted by one or more central processing units (CPUs) or one or more micro processing units (MPUs). The control unit 202 controls an entirety of the NAN 101 by executing the program stored in the storage unit 201. It is noted that the control unit 202 may control the entirety of the NAN 101 through collaboration between the program stored in the storage unit 201 and an operating system (OS).

In addition, the control unit 202 controls the function unit 203 to execute predetermined processing such as image capturing, printing, or projection. The function unit 203 is hardware for the NAN 101 to execute predetermined processing. For example, in a case where the NAN 101 functions as a camera, the function unit 203 is an image capturing unit and performs image capturing processing. In addition, for example, in a case where the NAN 101 functions as a printer, the function unit 203 is a printing unit and performs printing processing. In addition, for example, in a case where the NAN 101 functions as a projector, the function unit 203 is a projection unit and performs projection processing. Data to be processed by the function unit 203 may be data stored in the storage unit 201 or may be data communicated with another NAN device via the communication unit 206 described below.

The input unit 204 accepts various operations from a user. The display unit 205 displays various information to the user. It is noted that both the input unit 204 and the display unit 205 may be realized by a single module like a touch panel.

The communication unit 206 performs control on the wireless communication compliant with the IEEE 802.11 standard series and control on IP communication. In addition, the communication unit 206 controls the antenna 207 to transmit and receive a wireless signal for the wireless communication. The NAN 101 communicates contents such as image data, document data, and video data with another communication apparatus via the communication unit 206. Under the control by the control unit 202, in the DW period in which the wireless signal is not transmitted or received, the communication unit 206 may be put into a DOZE state without receiving power supply.

FIG. 3 is a block diagram illustrating a functional configuration example of the NAN 101. As a functional configuration, the NAN 101 has, for example, a wireless LAN control unit 301, a frame processing unit 302, a NAN control unit 303, and a UI control unit 304.

The wireless LAN control unit 301 performs control for performing transmission and reception of the wireless signal with another wireless LAN apparatus such as the NAN device. For example, the wireless LAN control unit 301 executes communication control of the wireless LAN following the IEEE 802.11 standard series.

The frame processing unit 302 performs analysis of a frame received by the wireless LAN control unit 301 and processing of creating a frame following instructions of the NAN control unit 303.

The NAN control unit 303 performs control following the NAN standard. For example, the NAN control unit 303 performs the communication control following the NAN standard via the communication unit 206 (FIG. 2).

The UI control unit 304 controls display of various information to the output unit 205 (FIG. 2) and also manages operations performed on the input unit 204 by the user of the device 101 to transfer necessary signals to other function units.

### Embodiment 1

An example is illustrated according to the present embodiment in which an operation mode field 403 indicates that the NAN device supports EHT and that the NAN device is capable of using a frequency bandwidth of 320 MHz while keeping 1 byte.

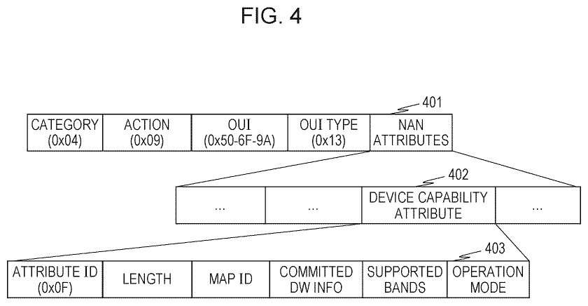

FIG. 4 illustrates a frame format of an extended service discovery frame compliant with the NAN standard.

The extended service discovery frame has a category field, an action field, an OUI field, an OUI type field, and a NAN attributes field 401. In addition, the NAN attributes field 401 includes at least one or more attributes.

According to the present embodiment, the NAN attributes field 401 includes at least a device capability attribute field 402.

The device capability attribute field 402 is an attribute indicating a function of the NAN device and includes, for example, information of a frequency band and version information of an IEEE 802.11 series which can be used by the NAN device.

The device capability attribute field 402 has the following. That is, the field includes an attribute ID field, a length field, a map ID field, a committed DW info field, a supported bands field, and an operation mode field.

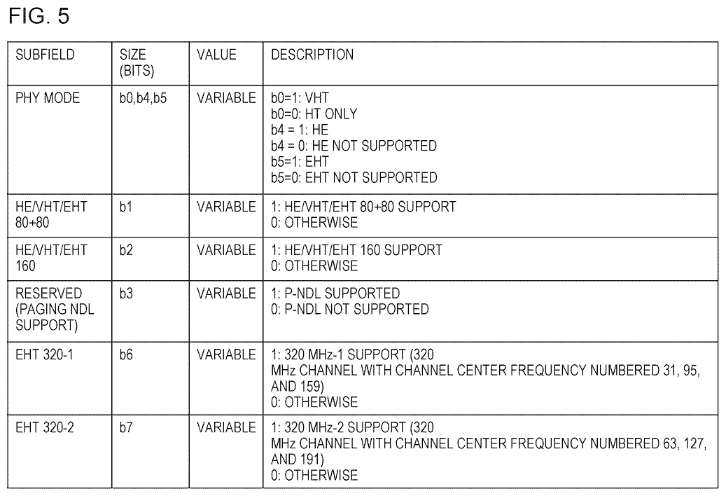

The operation mode field 403 is represented by 1 byte of b0 to b7. FIG. 5 illustrates a detail of the operation mode field 403 illustrated in FIG. 4.

In a case where 1 is stored in b0 in the operation mode field 403, it is indicated that the NAN device supports VHT. In a case where 0 is stored in b0 in the operation mode field 403, it is indicated that the NAN device supports only HT. Herein, VHT refers to the IEEE 802.11ac standard, and HT refers to the IEEE 802.11n standard. In addition, in a case where 1 is stored in b4 in the operation mode field 403, it is indicated that the NAN device supports HE, and in a case where 0 is stored in b4, it is indicated that the NAN device does not support HE. Herein, HE refers to IEEE 802.11ax. Furthermore, in a case where 1 is stored in b5 in the operation mode field 403, it is indicated that the NAN device supports EHT, and in a case where 0 is stored in b5, it is indicated that the NAN device does not support EHT. Herein, EHT refers to the IEEE 802.11be standard.

In addition, the NAN device which supports VHT, HE, or EHT can perform data communication by using a frequency bandwidth of 160 MHz. In a case where 1 is stored in b1 in the operation mode field 403, it is indicated that the NAN device is capable of using a frequency bandwidth of 80+80 MHz. In addition, in a case where 0 is stored in b1 in the operation mode field 403, it is indicated that the NAN device is not capable of using the frequency bandwidth of 80+80 MHz. In addition, in a case where 1 is stored in b2 in the operation mode field 403, it is indicated that the NAN device is capable of using the frequency bandwidth of 160 MHz. In addition, in a case where 0 is stored in b2 in the operation mode field 403, it is indicated that the NAN device is not capable of using the frequency bandwidth of 160 MHz.

Furthermore, since the IEEE 802.11be standard, it is possible to perform communication in a frequency bandwidth of 320 MHz. In addition, according to the IEEE 802.11be standard, a frequency bandwidth of 320 MHz having 31 ch, 95 ch, and 159 ch as a center frequency in the frequency bandwidth of 320 MHz is defined as a frequency bandwidth of 320-1 MHz. Furthermore, a frequency bandwidth of 320 MHz having 63 ch, 127 ch, and 191 ch as the center frequency in the frequency bandwidth of 320 MHz is defined as a frequency bandwidth of 320-2 MHz. In a case where 1 is stored in b6 in the operation mode field 403, it is indicated that the NAN device is capable of using the frequency bandwidth of 320-1 MHz. In addition, in a case where 0 is stored in b6 in the operation mode field 403, it is indicated that the NAN device is not capable of using the frequency bandwidth of 320-1 MHz. In addition, in a case where 1 is stored in b7 in the operation mode field 403, it is indicated that the NAN device is capable of using the frequency bandwidth of 320-2 MHz. In addition, in a case where 0 is stored in b7 in the operation mode field 403, it is indicated that the NAN device is not capable of using the frequency bandwidth of 320-2 MHZ.

According to the present embodiment, in the operation mode field of the device capability attribute field, it becomes possible to indicate that the NAN device supports EHT. Furthermore, in the operation mode field, it becomes possible to indicate that the NAN device supports the frequency bandwidth of 320 MHz. When it is possible to indicate whether or not the NAN device is capable of using EHT and the frequency bandwidth of 320 MHZ, for example, after the service is discovered by Wi-Fi Aware, it becomes possible to perform EHT compliant communication in the PostNAN communication.

### Embodiment 2

In Embodiment 1, while keeping 1 byte, the operation mode field represents a field indicating that the NAN device supports EHT and that the NAN device supports the frequency bandwidth of 320 MHz. According to the present embodiment, an example will be illustrated in which in an extended operation mode field obtained by extending the operation mode field illustrated in Embodiment 1, it is indicated that the NAN device supports EHT and the frequency bandwidth of 320 MHz. In addition, in Embodiment 1, it is indicated whether or not the NAN device is capable of using the frequency bandwidth of 320-1 MHz and 320-2 MHz as the bandwidth of 320 MHz. According to the present embodiment, it is possible to indicate whether or not the NAN device is capable of using a frequency bandwidth of 160+160 MHz in addition to the frequency bandwidth of 320-1 MHZ and 320-2 MHz.

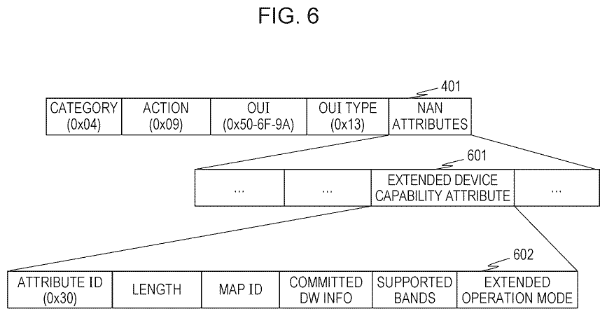

FIG. 6 illustrates the frame format of the extended service discovery frame compliant with the NAN standard.

The extended service discovery frame has the category field, the action field, the OUI field, the OUI type field, and the NAN attributes field 401. In addition, the NAN attributes field 401 includes at least one or more attributes. According to the present embodiment, the NAN attributes field 401 includes an extended device capability attribute field 601.

The extended device capability attribute field is a field indicating a function of the NAN device and includes, for example, version information of the IEEE 802.11 series and information of a frequency band which can be used by the NAN device.

The extended device capability attribute field 601 has the following fields. That is, the field has the attribute ID field, the length field, the map ID field, the committed DW info field, the supported bands field, and an extended operation mode field.

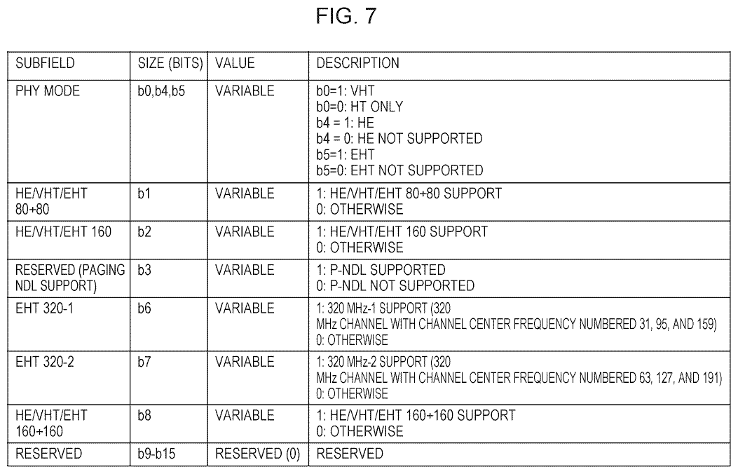

An extended operation mode field 602 is represented by 2 bytes of b0 to b15. FIG. 7 illustrates a detail of the extended operation mode field 602 illustrated in FIG. 6.

In a case where 1 is stored in b0 in the extended operation mode field 602, it is indicated that the NAN device supports VHT. In a case where 0 is stored in b0 in the extended operation mode field 602, it is indicated that the NAN device supports only the HT. In addition, in a case where 1 is stored in b4 in the extended operation mode field 602, it is indicated that the NAN device supports HE. In a case where 0 is stored in b4 in the extended operation mode field 602, it is indicated that the NAN device does not support HE.

The NAN device which supports VHT, HE, or EHT can perform data communication by using the frequency bandwidth of 160 MHz. In a case where 1 is stored in b1 in the extended operation mode field 602, it is indicated that the NAN device is capable of using the frequency bandwidth of 80+80 MHz. In a case where 0 is stored in b1 in the extended operation mode field 602, it is indicated that the NAN device is not capable of using the frequency bandwidth of 80+80 MHz. In addition, in a case where 1 is stored in b2 in the extended operation mode field 602, it is indicated that the NAN device is capable of using the frequency bandwidth of 160 MHz. In a case where 0 is stored in b2 in the extended operation mode field 602, it is indicated that the NAN device is not capable of using the frequency bandwidth of 160 MHz.

Furthermore, in a case where 1 is stored in b5 in the extended operation mode field 602, it is indicated that the NAN device supports EHT, and in a case where 0 is stored in b5, it is indicated that the NAN device does not support EHT. Furthermore, in a case where 1 is stored in b6 in the extended operation mode field 602, it is indicated that the NAN device is capable of using the frequency bandwidth of 320-1 MHz. In a case where 0 is stored in b6 in the extended operation mode field 602, it is indicated that the NAN device is not capable of using the frequency bandwidth of 320-1 MHz. In addition, in a case where 1 is stored in b7 in the extended operation mode field 602, it is indicated that the NAN device is capable of using the frequency bandwidth of 320-2 MHz. In a case where 0 is stored in b6 in the extended operation mode field 602, it is indicated that the NAN device is not capable of using the frequency bandwidth of 320-2 MHz.

Furthermore, in a case where 1 is stored in b8 in the extended operation mode field 602, it is indicated that the NAN device is capable of using the frequency bandwidth of 160 MHz+160 MHz. In a case where 0 is stored in b6 in the extended operation mode field 602, it is indicated that the NAN device is not capable of using the frequency bandwidth of 160 MHz+160 MHz.

According to the present embodiment, in the newly defined extended operation mode field, it becomes possible to indicate whether or not the NAN device supports EHT and whether or not the NAN device is capable of using the frequency bandwidth of 320 MHz. Furthermore, since the extended operation mode field is defined by 2 bytes, it becomes possible to indicate whether or not the NAN device is capable of using the frequency bandwidth of 160+160 MHz in addition to the frequency bandwidth of 320-1 MHz/320-2 MHz. When it is possible to indicate whether or not the NAN device is capable of using EHT and the frequency bandwidth of 320 MHz, for example, after the service is discovered by Wi-Fi Aware, it becomes possible to perform EHT compliant communication in the PostNAN communication.

### Embodiment 3

In Embodiment 2, the example has been illustrated in which in the newly defined extended operation mode field, it is indicated that the NAN device supports EHT and that the NAN device supports the frequency bandwidth of 320 MHz. According to the present embodiment, an example will be illustrated in which it is indicated whether or not the NAN device supports EHT and the frequency bandwidth of 320 MHZ by a device capability attribute and an extended operating bandwidth attribute, respectively.

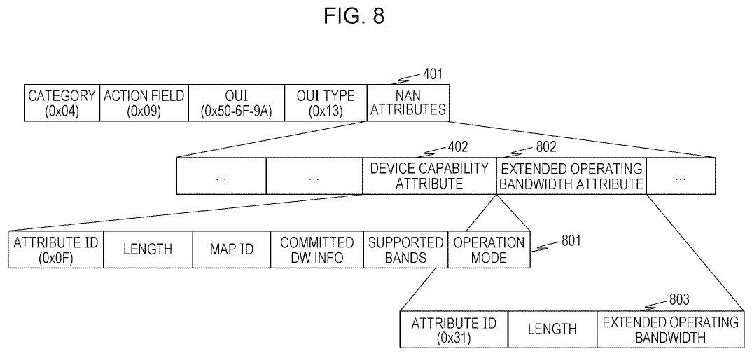

FIG. 8 illustrates the frame format of the extended service discovery frame compliant with the NAN standard.

The extended service discovery frame has the following. That is, the frame has the category field, the action field, the OUI field, the OUI type field, and the NAN attributes field 401. The NAN attributes field 401 includes at least one or more attributes.

The NAN attributes field 401 of the present embodiment includes the device capability attribute field 402 and an extended operating bandwidth attribute field 802.

The device capability attribute field 402 and the extended operating bandwidth attribute field are fields in which the following information is stored. That is, those fields are fields indicating the function of the NAN device and include, for example, version information of the IEEE 802.11 series and information of the frequency band which can be used by the NAN device.

The device capability attribute field 402 includes information indicating whether or not the NAN device supports EHT according to the present embodiment. In addition, the extended operating bandwidth attribute field 802 includes information of the frequency bandwidth of 320 MHz which can be used by the NAN device.

The device capability attribute field 402 has the following. That is, the field has the attribute ID field, the length field, the map ID field, the committed DW info field, the supported bands field, and an operation mode field 801.

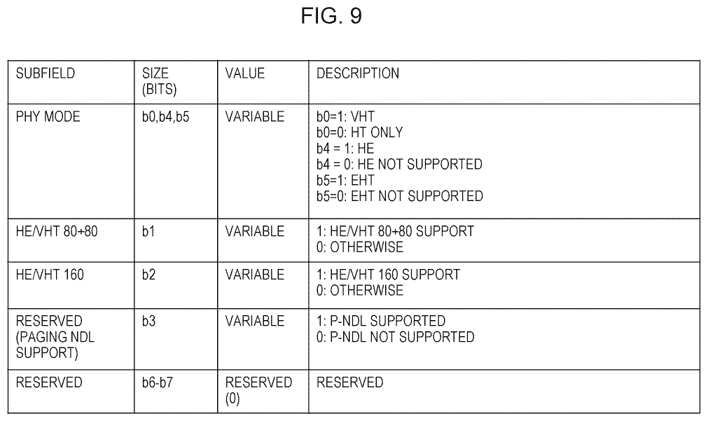

The operation mode field 801 includes information illustrated in FIG. 9 described below, and the operation mode field 801 is represented by 1 byte of b0 to b7.

A detail of the operation mode field 801 according to the present embodiment is illustrated in FIG. 9. The operation mode field 801 according to the present embodiment includes information on whether or not the NAN device supports EHT and information on whether or not the NAN device supports the bandwidth of 80+80 MHz and the bandwidth of 160 MHZ.

In a case where 1 is stored in b0 in the operation mode field 801, it is indicated that the NAN device supports VHT. In a case where 0 is stored in b0 in the operation mode field 801, it is indicated that the NAN device supports only the HT. In addition, in a case where 1 is stored in b4 in the operation mode field 801, it is indicated that the NAN device supports HE, and in a case where 0 is stored in b4, it is indicated that the NAN device does not support HE. Furthermore, in a case where 1 is stored in b5 in the operation mode field 801, it is indicated that the NAN device supports EHT, and in a case where 0 is stored in b5, it is indicated that the NAN device does not support EHT.

The NAN device which supports VHT, HE, or EHT can perform data communication by using the frequency bandwidth of 160 MHz. In a case where 1 is stored in b1 in the operation mode field 801, it is indicated that the NAN device is capable of using the frequency bandwidth of 80+80 MHz. In a case where 0 is stored in b1 in the operation mode field 801, it is indicated that the NAN device is not capable of using the frequency bandwidth of 80+80 MHZ. In addition, in a case where 1 is stored in b2 in the operation mode field 801, it is indicated that the NAN device is capable of using the frequency bandwidth of 160 MHz. In a case where 0 is stored in b2 in the operation mode field 801, it is indicated that the NAN device is not capable of using the frequency bandwidth of 160 MHZ.

The extended operating bandwidth attribute field 802 includes the attribute ID field, the length field, and an extended operating bandwidth field 803.

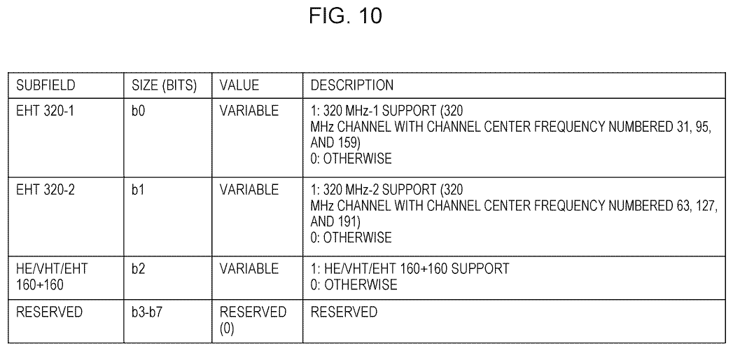

A detail of the extended operating bandwidth field 803 is illustrated in FIG. 10. The extended operating bandwidth field 803 is represented by 1 byte and includes information of the frequency bandwidth of 320 MHz which can be used by the NAN device.

In a case where 1 is stored in b0 in the extended operating bandwidth field 803, it is indicated that the NAN device is capable of using the frequency bandwidth of 320-1 MHz. In a case where 0 is stored in b0 in the extended operating bandwidth field 803, it is indicated that the NAN device is not capable of using the frequency bandwidth of 320-1 MHz. In addition, in a case where 1 is stored in b1 in the extended operating bandwidth field 803, it is indicated that the NAN device is capable of using the frequency bandwidth of 320-2 MHZ. In a case where 0 is stored in b1 in the extended operating bandwidth field 803, it is indicated that the NAN device is not capable of using the frequency bandwidth of 320-2 MHZ.

Furthermore, in a case where 1 is stored in b2 in the extended operating bandwidth field 803, it is indicated that the NAN device is capable of using the frequency bandwidth of 160 MHz+160 MHz. In a case where 0 is stored in b2 in the extended operating bandwidth field 803, it is indicated that the NAN device is not capable of using the frequency bandwidth of 160 MHz+160 MHZ.

According to the present embodiment, it becomes possible to indicate whether or not the NAN device is capable of using EHT and the frequency bandwidth of 320 MHZ by using the two attributes. When it is possible to indicate whether or not the NAN device is capable of using EHT and the frequency bandwidth of 320 MHZ, for example, after the service is discovered by Wi-Fi Aware, it becomes possible to perform EHT compliant communication in the PostNAN communication.

### OTHER EMBODIMENTS

According to the present embodiment, the NAN compliant extended SDF has been illustrated but is not limited to this.

For example, information included in NAN attributes illustrated in the present embodiment may be appended to information content of a NAN action frame and NAN attributes of NAN information elements. It is noted that the NAN information elements are elements to be appended to the NAN sync beacon and the NAN discovery beacon.

In addition, a name of a field/subfield and a position and size of a bit are not limited to ones described in a table, and similar information may be stored in a different field name/subfield name or in a different order or size.

In addition, according to the present embodiment, the frequency bandwidth of 320 MHz is represented by the two types of the frequency bandwidth of 320-1 MHz and the frequency bandwidth of 320-2 MHz, but a field indicating whether or not the frequency bandwidth of 320 MHz can be used may be prepared.

It is noted that a recording medium having recorded thereon a program code of software which realizes the above-described function may be supplied to a system or an apparatus, and a computer (a CPU or an MPU) of the system or the apparatus may read out and execute the program code stored in the recording medium. In this case, the program code itself read out from the storage medium realizes the function of the above-described embodiment, and the storage medium storing the program code configures the above-described apparatus.

As the storage medium for supplying the program code, for example, a flexible disc, a hard disc, an optical disc, a magnetooptical disc, a CD-ROM, a CD-R, a magnet tape, a nonvolatile memory card, a ROM, a DVD, and the like can be used.

In addition, not only the above-described function is realized by executing the program code read out by the computer, but based on instructions of the program code, an OS running on the computer may perform part or all of actual processing to realize the above-described function. The OS is an abbreviation for operating system.

Furthermore, the program code read out from the storage medium is written to a memory provided to a function expansion board inserted into the computer or a function expansion unit connected to the computer. Then, based on instructions of the program code, a CPU provided to the function expansion board or the function expansion unit may perform part or all of the actual processing to realize the above-described function.

The present invention can also be realized by processing in which the program for realizing one or more functions of the above-described embodiments is supplied to the system or the apparatus via the network or the storage medium, and one or more processors in the computer of the system or the apparatus read out and execute the program. In addition, the present invention can be realized by a circuit which realizes one or more functions (for example, an ASIC).

According to the present invention, notification of the information regarding the communication compliant with the IEEE 802.11be standard is enabled in the Wi-Fi Aware standard.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A Wi-Fi Aware compliant communication apparatus comprising:
a communication unit configured to communicate a Wi-Fi Aware compliant frame, wherein
the frame communicated by the communication unit includes first indication information indicating whether the communication apparatus supports an IEEE 802.11be standard.

2. The Wi-Fi Aware compliant communication apparatus according to claim 1, wherein
the frame communicated by the communication unit includes second indication information indicating whether the communication apparatus is capable of using a specific frequency bandwidth exceeding 160 MHZ.

3. The communication apparatus according to claim 2, wherein the first indication information and the second indication information are included in a first attribute of the frame.

4. The communication apparatus according to claim 2, wherein the first indication information is included in a first attribute of the frame, and the second indication information is included in a second attribute which is different from the first attribute.

5. The communication apparatus according to claim 3, wherein the first attribute is a Wi-Fi Aware compliant device capability attribute.

6. The communication apparatus according to claim 2, wherein the specific frequency bandwidth exceeding 160 MHz is a frequency bandwidth of 320 MHz.

7. The communication apparatus according to claim 2, wherein the specific frequency bandwidth exceeding 160 MHz is a frequency bandwidth of 320-1 MHz which is defined by an IEEE 802.11 standard series.

8. The communication apparatus according to claim 2, wherein the specific frequency bandwidth exceeding 160 MHz is a frequency bandwidth of 320-2 MHz which is defined by an IEEE 802.11 standard series.

9. The communication apparatus according to claim 1, wherein the frame is a NAN action frame defined by Wi-Fi Aware.

10. The communication apparatus according to claim 1, wherein the frame is a service discovery frame (SDF) frame defined by Wi-Fi Aware.

11. The communication apparatus according to claim 1, wherein the frame is a NAN synchronization beacon defined by Wi-Fi Aware.

12. The communication apparatus according to claim 1, wherein the frame is a NAN discovery beacon defined by Wi-Fi Aware.

13. A communication method in a Wi-Fi Aware compliant communication apparatus, the method comprising:
communicating a Wi-Fi Aware compliant frame, wherein
the frame communicated in the communicating includes first indication information indicating whether the communication apparatus supports an IEEE 802.11be standard.

14. The communication method according to claim 13, wherein
the frame communicated in the communicating includes second indication information indicating whether the communication apparatus is capable of using a specific frequency bandwidth exceeding 160 MHz.

15. A non-transitory computer-readable storage medium storing a program for causing a computer to function as:
a communication unit configured to communicate a Wi-Fi Aware compliant frame, wherein
the frame communicated by the communication unit includes first indication information indicating whether the communication apparatus supports an IEEE 802.11be standard.
